(19) United States
(12) Patent Application Publication
(10) Pub. No.: US 2012/0177906 A1
(43) Pub. Date: Jul. 12, 2012

(54) POLYMERS WITH METAL FILLER FOR EMI SHIELDING

(75) Inventors: Jose R. Sousa, East Providence, RI (US); Jon M. Lenhert, Brea, CA (US); Chan S. Chung, Garden Grove, CA (US)

(73) Assignee: SAINT-GOBAIN PERFORMANCE PLASTICS CORPORATION, Aurora, OH (US)

(21) Appl. No.: 13/336,535

(22) Filed: Dec. 23, 2011

Related U.S. Application Data
(60) Provisional application No. 61/427,619, filed on Dec. 28, 2010.

(51) Int. Cl. B32B 27/04

(52) U.S. Cl. 428/297.4

(57) ABSTRACT

A composite material includes a thermoplastic material, and a metallic filler dispersed within the thermoplastic material. The metallic filler may be fibrous, particulate or a combination thereof. The metallic filler may have a length in a range of about 3 mm to about 10 mm, and/or a mean particle size of about 2 microns to about 10 microns. The composite material may have a volumetric resistivity of not greater than about 0.5 Ohm·cm. The composite material can be in the form of a sealing component.

### CROSS-REFERENCE TO RELATED APPLICATION(S)

The present application claims priority from U.S. Provisional Patent Application No. 61/427,619, filed Dec. 28, 2010, entitled “METAL FIBER FILLED POLYMERS FOR EMI SHIELDING,” and is incorporated herein by reference in its entirety.

### FIELD OF THE DISCLOSURE

The present disclosure relates generally to electromagnetic interference/radio frequency interference (EMI/RFI) sealing components. More specifically, the present disclosure relates to metal fiber filled polymers for EMI shielding.

### BACKGROUND

Electronic noise (EMI) and radio frequency interference (RFI) are the presence of undesirable electromagnetic energy in an electronic system. EMI can result from unintentional electromagnetic energy generated in and around the electronic system. For example, electrical wiring can generate electronic noise at about 60 Hz. Other sources of unintentional electromagnetic energy can include thermal noise, lightning, and static discharges. Additionally, EMI can result from intentional electromagnetic energy, such as radio signals used for radio and television broadcasts, wireless communication systems such as cellular phones, and wireless computer networks.

Elimination of EMI is important in the design of electronic systems. Placement of components within the system, as well as the use of shielding and filtering, make it possible to control and reduce the EMI that interferes with the function of the electronic system as well as the EMI produced by the electronic system that can interfere with other systems. The effectiveness of shielding and filtering is dependent on the methods by which the shielding materials are bonded together. Electrical discontinuities in the enclosure, such as joints, seams, and gaps, all affect the frequency and the amount of EMI that can breach the shielding.

### SUMMARY

In a first aspect, a composite material includes a thermoplastic material and one or more metallic fillers, such as metal particles, metal fiber filler, or a combination thereof. The metallic filler can be dispersed within the thermoplastic material. The composite material can have a volumetric resistivity of not greater than about 0.5 Ohm·cm.

In a second aspect, a sealing component can include a composite material comprised of a thermoplastic material and a metallic filler as described herein. The metallic filler can be dispersed within the thermoplastic material and have a length in a range of about 3 mm to about 10 mm, and a mean particle size of about 5 microns. The composite material can have a volumetric resistivity of not greater than about 0.5 Ohm·cm.

In a third aspect, a system can include a first component and a second component, and a sealing component positioned between the first and second components. The sealing component can include a composite material comprised of a thermoplastic material and a metallic filler. The metallic filler can be dispersed within the thermoplastic material and have a length in a range of about 3 mm to about 10 mm, and a mean particle size of about 1 micron to about 10 microns. The composite material can have a volumetric resistivity of not greater than about 0.5 Ohm·cm.

In an embodiment, the thermoplastic can include a polyketone, a polyethylene, a thermoplastic fluoropolymer, or any combination thereof. Exemplary thermoplastic fluoropolymers can include a fluorinated ethylene propylene (FEP), a polytetrafluoroethylene (PTFE), a terpolymer of tetrafluoroethylene, a hexafluoropropylene, and vinylidene fluoride (THV), a polychlorotrifluoroethylene (PCTFE), an ethylene tetrafluoroethylene copolymer (ETFE), an ethylene chlorotrifluoroethylene copolymer (ECTFE), or any combination thereof. Exemplary polyketones includes a polyetherketone (PEK), a poly ether etherketone (PEEK), a polyaryl ether ketone (PAEK), a polyether ketone ketone (PEKK), or any combination thereof. Exemplary polyethylenes can include a high density polyethylene (HDPE), a high molecular weight polyethylene (HMWPE), an ultra high molecular weight polyethylene (UHMWPE), a cross-linked polyethylene (PEX), a high density cross-linked polyethylene (HDXLPE), or combinations thereof.

In another embodiment of the first aspect, the metal fiber filler can have a length in a range of about 2 mm to about 20 mm, such as a length in a range of about 3 mm to about 10 mm, even a length in a range of about 4 mm to about 8 mm. Further, the metal fiber filler can have a diameter in a range of about 1 micron to about 25 microns, such as in a range of about 3 micron to about 15 microns, even in a range of about 5 micron to about 10 microns. The metal fibers also may be combined in various ratios with the metal particles, as a mixture to be blended with the polymer base material.

In another embodiment, the composite material can have a coefficient of friction of not greater than about 0.4, such as not greater than about 0.2, even not greater than about 0.15. Further, the composite material can have a deformation under load within a range of about 3% to about 15%. Additionally, the composite material can have a Young's Modulus from about 5 ksi to over 2000 ksi, such as about 12 ksi to about 900 ksi.

In yet another embodiment, the composite material can include an additional filler. The additional filler can be a conductive filler such as a metals and metal alloys, conductive carbonaceous materials, ceramics, or any combination thereof. In a particular embodiment, the composite materially can be substantially free of silica and silicate fillers.

### BRIEF DESCRIPTION OF THE DRAWINGS

The present disclosure may be better understood, and its numerous features and advantages made apparent to those skilled in the art by referencing the accompanying drawings.

FIG. 1 is a schematic view of an embodiment of a composite material;

FIG. 2 is an isometric view of an embodiment of a sealing component having a composite material; and

FIG. 3 is a sectional side view of a system having a sealing component with a composite material.

The use of the same reference symbols in different drawings indicates similar or identical items.

### DETAILED DESCRIPTION

In an embodiment, an EMI/RFI sealing component can reduce electromagnetic noise caused by radio frequency interference passing through a gap in an enclosure. The EMI/RFI gasket can include a composite material comprising a polymer and a metal fiber filler dispersed within the polymer.

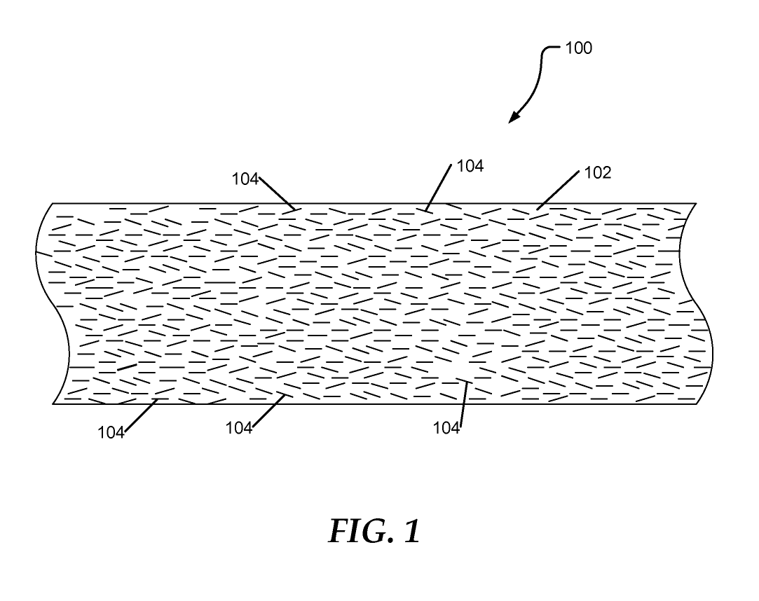

FIG. 1 shows an exemplary composite material 100. The composite material 100 includes a polymer 102 and a filler 104. In an embodiment, the polymer 102 can include a thermoplastic material, such as an engineering or high performance thermoplastic polymer. For example, the thermoplastic material may include a polyketone, a polyaramid, a thermoplastic polyimide, a polyetherimide, a polyphenylene sulfide, a polyethersulfone, a polysulfone, a polyphenylene sulfone, a polyamideimide, an ultra high molecular weight polyethylene, a thermoplastic fluoropolymer, a polyamide, a polybenzimidazole, a liquid crystal polymer, or any combination thereof.

In a particular embodiment, the thermoplastic material can be a thermoplastic fluoropolymer, a polyethylene, and a polyketone. The polyketone can include a polyether ether ketone (PEEK), a polyether ketone (PEK), a polyether ketone ketone (PEKK), a polyaryl ether ketone (PAEK), polyether ketone ether ketone ketone, a derivative thereof, or a combination thereof. An exemplary thermoplastic fluoropolymer includes fluorinated ethylene propylene (FEP), polytetrafluoroethylene (PTFE), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), or any combination thereof. Examples of polyethylene may include a high density polyethylene (HDPE), a high molecular weight polyethylene (HMWPE), an ultra high molecular weight polyethylene (UHMWPE), a cross-linked polyethylene (PEX), a high density cross-linked polyethylene (HDXLPE), or combinations thereof. Other thermoplastic resins may include polyvinylidene fluoride (PVDF), perfluoroalkoxy (PFA) or combinations thereof.

In addition, thermosets may be used in place of the thermoplastics. Thermosets may include polymers such as polyimide, polyester, etc., or combinations thereof.

In an embodiment, the filler 104 can include a metallic fiber, particle or powder. For example, some embodiments of filler 104 include nickel particles or powder. Other embodiments comprise silver-coated tin. Alternatively, the metallic fiber may comprise stainless steel fiber, bronze fiber, aluminum fiber, nickel fiber, or any combination thereof. The metallic fiber can have a length in a range of about 2 mm to about 20 mm, such as in a range of about 3 mm to about 10 mm, even in a range of between about 4 mm and about 8 mm. Further, the metallic fiber can have a diameter in a range of about 1 micron to about 25 microns, such as in a range of about 3 micron to about 15 microns, even in a range of about 5 micron to about 10 microns. In some embodiments, the filler may comprise about 40% to about 60%, by weight, of the composite material.

In an exemplary embodiment, the composite material can include at least about 15.0 wt % metal fiber filler. For example, the composite material may include at least about 20.0 wt % metal fiber filler, such as at least about 25.0 wt % metal fiber filler, at least about 30.0 wt %, or even at least about 35.0 wt % of the metal fiber filler.

The metal fibers can increase the ability of current to pass through the composite material and can reduce the resistivity of the composite material. In an embodiment, the composite material can have a volume resistivity of not greater than about 10 Ohm·cm, not greater than about 5 Ohm·cm, not greater than about 1 Ohm·cm, not greater than about 0.5 Ohm·cm, such as not greater than about 0.1 Ohm·cm, such as not greater than about 0.05 Ohm·cm, even not greater than about 0.01 Ohm·cm. In a particular embodiment, the volumetric resistivity can be at least about 0.00001 Ohm·cm.

In a further embodiment, the composite material can include additional conductive fillers, such as metals and metal alloys, conductive carbonaceous materials, ceramics such as borides and carbides, or any combination thereof. These materials may be fibers or particulates in form.

In an example, metals and metal alloys can include bronze, aluminum, gold, nickel, silver, alloys thereof, or any combination thereof. Examples of conductive carbonaceous materials include carbon fibers, sized carbon fibers, PAN carbon fibers, carbon nanotubes, carbon nanofibers, carbon black, graphite, extruded graphite, and the like.

Additionally, the conductive carbonaceous materials can include carbon fibers and polymer fibers coated with vapor deposited metals, such as silver, nickel, and the like. Examples of ceramics can include borides and carbides. Additionally, the ceramics can be coated or doped ceramics. In a particular embodiment, the conductive filler can be finely dispersed within the composite material. Conductive fillers can be employed to increase the conductivity of the composite material.

In an exemplary embodiment, the composite material can include a total amount of conductive fillers (metal fiber filler and additional conductive fillers) of at least about 20.0 wt %. For example, the composite material may include a total amount of conductive fillers of at least about 30.0 wt %, such as at least about 40.0 wt %, at least about 50.0 wt %, at least about 60.0 wt %, or even at least about 70.0 wt %. However, too much resistivity modifier may adversely influence physical or mechanical properties. As such, the total amount of conductive fillers may not be greater than about 95.0 wt %, such as not greater than about 90.0 wt %, or not greater than about 85.0 wt %. In another example, the composite material may include not greater than about 75.0 wt % total conductive filler. In a particular example, the composite material includes a total amount of conductive filler in a range of about 40.0 wt % to about 75.0 wt %, such as a range of about 50.0 wt % to about 75.0 wt %, or even about 60.0 wt % to about 75.0 wt %.

Additionally, the composite material can include other additives to impart particular properties to the polymer, such as, for example, pigments, biocides, flame retardants, antioxidants, and the like. Exemplary pigments include organic and inorganic pigments.

In some embodiments, the composite material can be substantially free of non-conductive silica fillers that may reduce conductivity between the metal fiber fillers and the other conductive fillers. Examples of silica fillers can include silica, precipitated silica, alumina silicates, thermal silica, also called pyrogenic silica, and non-pyrogenic silica. Silica may be used in small amounts to improve dispersion of materials that are difficult to blend.

In a particular embodiment, the composite material can have a relatively low coefficient of friction. For example, the coefficient of friction of the composite material can be not greater than about 0.4, such as not greater than about 0.2, even not greater than about 0.15.

In an embodiment, the composite material can be a relatively stiff material. A Young's modulus can be a measure of the stiffness of the composite material and can be determined from the slope of a stress-strain curve during a tensile test on a sample of the material. The composite material can have a Young's modulus of from about 5 ksi to over 2000 ksi. Generally, the composite material can have a Young's modulus of about 12 ksi to about 900 ksi.

In an embodiment, the composite material can be resistant to deformation. Deformation under load can be a measure of the resistance to deformation of the composite material and can be determined according to ASTM D-621 by applying a load to a sample of the composite material for 2000 hours and measuring the loss in height of the sample. The composite material can have a deformation under load of within a range of about 3% to about 15%.

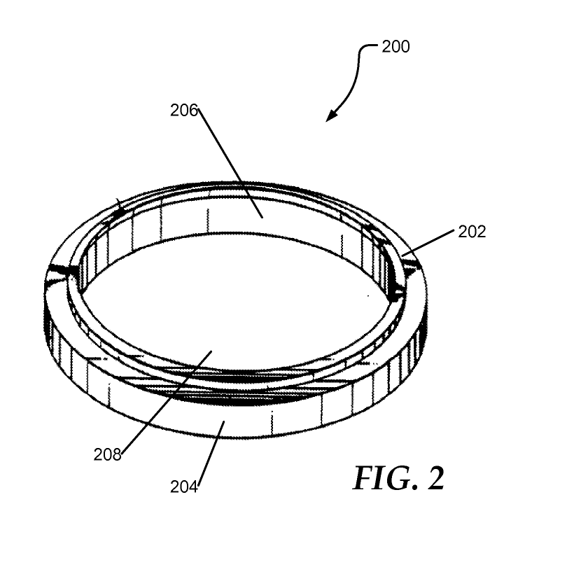

FIG. 2 shows an exemplary sealing component 200 according to an aspect of the present disclosure. The seal component 200 may comprise a seal, a gasket, a back-up ring, etc., and perform as a structural support component for a sealing device or system. For example, seal component 200 may include a ring 202 with an outside surface 204 and an inside surface 206 defining an opening 208 through the ring.

The gasket 200 can be used in an electronic system to reduce EMI/RFI and provide a chemical resistant environmental seal. In a particular embodiment, the gasket 200 can be placed between two parts of an electronics enclosure, such as between a body and a lid. In another particular embodiment, the gasket 200 having a low coefficient of friction can be used between a static component and a rotary component.

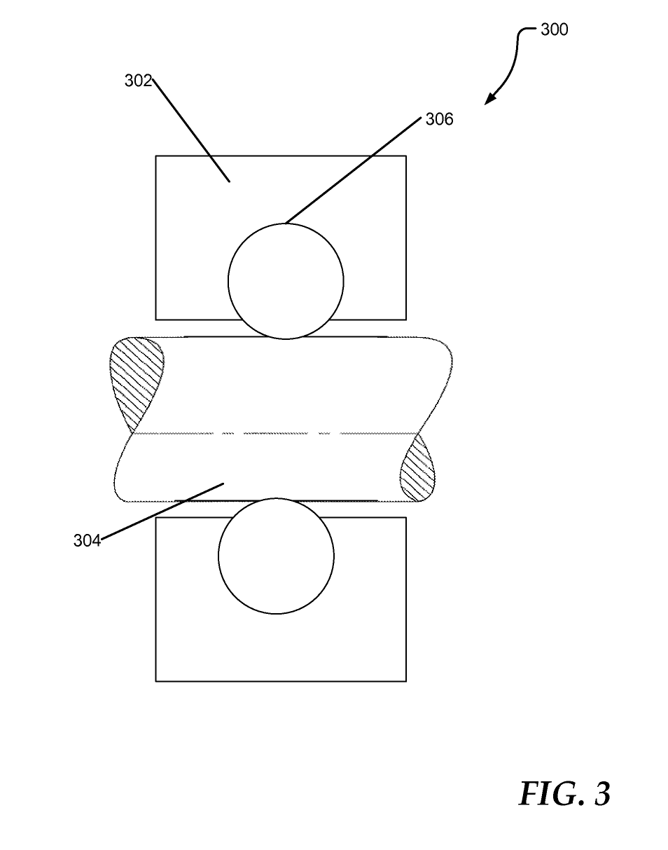

FIG. 3 illustrates an exemplary system 300. System 300 can include a static component 302 and a rotating component 304. The rotating component 304 can rotate relative to the static component 302. The system 300 can further include a sealing component 306, such as an annular seal, placed between the static component 302 and the rotating component 304. The sealing component 306 can be similar to sealing component 200. In an embodiment, the sealing component 306 can act to prevent environmental contamination, such as by dust, water, chemicals, gases, or the like, from entering into or exiting the system through the gap between the static component 302 and the rotating component 304. Additionally, the sealing component 306 can act to reduce EMI/RFI from affecting the system or emanating from the system.

Turning to the method of making the composite material, the metal fibers can be combined with a polymer material to form a blended powder. In a particular embodiment, the polymer material can be a thermopolymer, such as a polyketone, a polyethylene, or a thermoplastic fluoropolymer. The thermopolymer can be added in a powder or pellet form and can be mixed with the metal fibers, such as by blending, for example in a Brabender mixer or a Patterson Kelley blender, or milling, such as by dry milling, for example in a hammer mill. The presence of the fibers, such as stainless steel fibers, can make or render the thermoplastic material, composite material, seal component, or system non-extrudable.

The blended powder can be formed in a desired shape, such as by pressing into a mold. In this process the mold temperature may be ambient or elevated up to a particular melt temperature as necessary. Additionally, the blended powder can be sintered, either within the mold or can be heated or otherwise bonded together to form a green body that can be removed from the mold prior to sintering. Further, the composite material may be machined after shaping to form the seal body, or skived to produce sheet.

In a particular embodiment, the blended powder can be compressed into the mold and sintered. After sintering, the mold can be removed from the sintering oven and subjected to additional compression while the composite material remains at an elevated temperature. After cooling, the composite material can be machined to remove excess material and produce a final desired shape, such as a gasket or seal.

### Examples

Samples are tested according to ASTM D 991, ASTM D 4496, or Mil DTL 83528-C to determine volume resistivity. The results are provided in Table 1.

Comparative Sample 1 is Fluoralloy A56 (commercially available from Saint-Gobain) and includes PTFE and a carbon filler.

Sample 1 is prepared by blending a metal fiber filler (35 wt %), carbon filler (5 wt %), and PTFE (60 wt %). The metal fiber filler is blended in a Patterson Kelley Blender to separate the metal fibers. Carbon filler and PTFE are added to the metal fiber filler and blended together with the Patterson Kelley Blender. The resulting blended powder is compression molded and sintered to form Sample 1.

TABLE 1

| | Volume Resistivity | Deformation | Young's |
|---|---|---|---|
| | (Ohm-cm) | Under Load (%) | Modulus |
| Comparative | 4.15 | 10 | 120-150 ksi |
| Sample 1 | | | |
| Sample 1 | 0.13 | 14 | 185 ksi minimum |

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A composite material, comprising:
a thermoplastic material;
metallic fibers dispersed within the thermoplastic material to render the composite material non-extrudable; and
the composite material has a volumetric resistivity of not greater than about 0.5 Ohm·cm.

2. The composite material of claim 1, wherein the metallic fibers have a length in a range of about 2 mm to about 20 mm.

3. The composite material of claim 1, wherein the metallic filler further comprises metallic particles.

4. The composite material of claim 3, wherein the metallic particles have a diameter in a range of about 1 micron to about 25 microns.

5. The composite material of claim 3, wherein the metallic particles have a mean particle size in a range of about 1 micron to about 10 microns.

6. The composite material of claim 1, wherein the volumetric resistivity is not greater than about 0.1 Ohm·cm.

7. The composite material of claim 1, wherein the composite material has a coefficient of friction of not greater than about 0.4.

8. The composite material of claim 1, wherein the composite material has a deformation under load in a range of about 3% to about 15%.

9. The composite material of claim 1, wherein the composite material has a Young's Modulus of at least about 5 ksi.

10. The composite material of claim 1, wherein the composite material has a Young's Modulus in a range of about 12 ksi to about 900 ksi.

11. The composite material of claim 1, further comprising a metal, metal alloy, conductive carbonaceous material, ceramic, or any combination thereof.

12. The composite material of claim 1, wherein the thermoplastic material comprises polyketone, polyethylene, thermoplastic fluoropolymer, or any combination thereof.

13. The composite material of claim 12, wherein:
the polyketone comprises polyetherketone (PEK), poly ether etherketone (PEEK), polyaryl ether ketone (PAEK), polyether ketone ketone (PEKK), or any combination thereof;
the polyethylene comprises high density polyethylene (HDPE), high molecular weight polyethylene (HMWPE), ultra high molecular weight polyethylene (UHMWPE), cross-linked polyethylene (PEX), high density cross-linked polyethylene (HDXLPE), or any combination thereof; and
the thermoplastic fluoropolymer comprises fluorinated ethylene propylene (FEP), polytetrafluoroethylene (PTFE), a terpolymer of tetrafluoroethylene, hexafluoropropylene, vinylidene fluoride (THV), polychlorotrifluoroethylene (PCTFE), ethylene tetrafluoroethylene copolymer (ETFE), ethylene chlorotrifluoroethylene copolymer (ECTFE), or any combination thereof.

14. The composite material of claim 1, wherein the metallic fibers comprise stainless steel, nickel, silver-coated tin, or a combination thereof.

15. A sealing component, comprising:
a thermoplastic material;
a metallic fiber filler dispersed within the thermoplastic material, the metallic fiber filler having a length in a range of about 2 mm to about 20 mm; and
the sealing component has a volumetric resistivity of not greater than about 0.5 Ohm·cm.

16. The sealing component of claim 15, wherein the metallic fiber filler renders the sealing component non-extrudable, and the length is in the range of about 3 mm to about 10 mm.

17. The sealing component of claim 16, further comprising a metallic particle having a diameter in a range of about 1 micron to about 25 microns.

18. The sealing component of claim 17, wherein the metallic particle has a mean particle size in a range of about 1 micron to about 10 microns.

19. The sealing component of claim 15, wherein the volumetric resistivity is not greater than about 0.1 Ohm·cm.

20. The sealing component of claim 15, wherein the sealing component has a coefficient of friction of not greater than about 0.4.

21. The sealing component of claim 15, wherein the sealing component has a deformation under load in a range of about 3% to about 15%.

22. The sealing component of claim 15, wherein the sealing component has a Young's Modulus of at least about 5 ksi.

23. The sealing component of claim 15, wherein the sealing component has a Young's Modulus in a range of about 12 ksi to about 900 ksi.

24. The sealing component of claim 15, further comprising a metal, metal alloy, conductive carbonaceous material, ceramic, or any combination thereof.

25. The sealing component of claim 15, wherein the thermoplastic material comprises polyketone, polyethylene, thermoplastic fluoropolymer, or any combination thereof.

26. The sealing component of claim 15, wherein the metallic fiber filler comprises stainless steel, nickel, silver-coated tin, or a combination thereof.

27. A system, comprising:
a first component;
a second component; and
a sealing component between the first and second component; the sealing component comprising:
a thermoplastic material;
a metallic fiber filler dispersed within the thermoplastic material, the metallic fiber filler having a length in a range of about 2 mm to about 20 mm; and
the sealing component has a volumetric resistivity of not greater than about 0.5 Ohm·cm.

28. The system of claim 27, wherein the metallic fiber filler renders the sealing component non-extrudable.

29. The system of claim 27, further comprising a metallic particle filler having a mean size in a range of about 2 microns to about 10 microns.

30. The system of claim 29, wherein the metallic particle filler has a diameter in a range of about 1 micron to about 25 microns.

31. The system of claim 27, wherein the volumetric resistivity is not greater than about 0.1 Ohm·cm.

32. The system of claim 27, wherein the sealing component has a coefficient of friction of not greater than about 0.4.

33. The system of claim 27, wherein the sealing component has a deformation under load in a range of about 3% to about 15%.

34. The system of claim 27, wherein the sealing component has a Young's Modulus of at least about 5 ksi.

35. The system of claim 27, wherein the sealing component has a Young's Modulus in a range of about 12 ksi to about 900 ksi.

36. The system of claim 27, further comprising a metal, metal alloy, conductive carbonaceous material, ceramic, or any combination thereof.

37. The system of claim 27, wherein the thermoplastic material comprises polyketone, polyethylene, thermoplastic fluoropolymer, or any combination thereof.

38. The system of claim 27, wherein the metallic filler comprises stainless steel, nickel, silver-coated tin, or a combination thereof.
